(19) United States
(12) Patent Application Publication
(10) Pub. No.: US 2004/0103570 A1
(43) Pub. Date: Jun. 3, 2004

(54) THREE DIMENSIONAL ADVERTISING DISPLAY AND ASSOCIATED METHOD OF USE

(75) Inventor: Mark Ruttenberg, Bloomington, IL (US)

Correspondence Address: BLACKWELL SANDERS PEPER MARTIN LLP, 720 OLIVE STREET, SUITE 2400, ST. LOUIS, MO, 63101, US

(73) Assignee: MONARCH ADVERTISING, INC., Normal, IL (US)

(21) Appl. No.: 10/604,476

(22) Filed: Jul. 24, 2003

Related U.S. Application Data
(60) Provisional application No. 60/319,429, filed on Jul. 26, 2002.
(60) Provisional application No. 60/466,088, filed on Apr. 28, 2003.

(51) Int. Cl. G09F 7/00

(52) U.S. Cl. 40/584

(57) ABSTRACT

A three-dimensional advertising display and method of use is disclosed. The advertising display includes a structure and a plurality of sides that cooperatively form an advertising display, wherein at least one side of the plurality of sides includes an electronic panel display and at least one side of the plurality of sides includes at least one printed advertisement. A triangular structure is preferred. Solely due to cost, only a single electronic panel display is preferred, however, if the cost of the electronic panel display decreases significantly, then an electronic panel display located on each side of the advertising display would be optimal.

### CROSS REFERENCE TO RELATED APPLICATIONS

This patent application claims priority to U.S. Provisional Pat. Appl. Ser. No. 60/319,429 filed Jul. 26, 2002, and U.S. Provisional Pat. Appl. Ser. No. 60/466,088 filed Apr. 28, 2003.

### BACKGROUND OF INVENTION

There are numerous places at the point-of-sale or the point-of-purchase, where customers are forced to stand in line for significant periods of time.

These lines or queues can be found at retail establishments including grocery stores, department stores, hardware stores, banks, amusement parks, hair salons, restaurants, and so forth. For the customer, this waiting in line or queue can be very boring and tedious. On a rare occasion, a printed display, e.g., advertisement, may be available that provides some material for the customer to read that operates as a minor diversion. Usually, this printed display can be read in a small fraction of the waiting time for the customer in the line or queue, which does very little to relieve the monotony for the customer. Also, this printed display can only be viewed by the customer from one particular angle. Therefore, customers in other lines or queues or customers leaving the point-of-sale or the point-of-purchase will not be exposed to this printed display.

The present invention is directed to overcoming one or more of the problems set forth above.

### SUMMARY OF INVENTION

In one aspect of this present invention, a three-dimensional advertising display is disclosed. The advertising display includes a frame and a plurality of sides that cooperatively form the advertising display, wherein at least one side of the plurality of sides includes an electronic panel display and at least one side of the plurality of sides of the advertising display includes at least one printed advertisement.

In another aspect of this present invention, a three-dimensional advertising display is disclosed. The advertising display includes a frame, a first side, a second side and a third side that cooperatively form the advertising display, wherein the first side includes an electronic panel display, the second side includes a first printed advertisement and the third side includes a second printed advertisement.

In yet another aspect of this present invention, a three-dimensional advertising display is disclosed. The advertising display includes a frame, a first side, a second side and a third side that cooperatively form the advertising display, wherein the first side includes a first electronic panel display, the second side includes a second electronic panel display and the third side includes a third electronic panel display.

In still another aspect of this present invention, a three-dimensional advertising display is disclosed. The advertising display includes a frame, a first side, a second side and a third side that cooperatively form an advertising display, wherein the frame includes a plurality of members, e.g., angle brackets, that provide support for the advertising display and secure the first side, the second side and the third side of the advertising display to each other.

In another aspect of this present invention, a three-dimensional advertising display is disclosed. The advertising display includes a frame, a first side, a second side and a third side that cooperatively form an advertising display, further including a support mechanism, e.g., pipe or pole, attached to the frame to support the advertising display near a point-of-sale or a point-of-purchase.

In yet another aspect of this present invention, a three-dimensional advertising display is disclosed. The advertising display includes a frame, a first side, a second side and a third side that cooperatively form an advertising display, further including an attachment mechanism that secures an electronic panel display within the frame for the advertising display.

In another aspect of this present invention, a three-dimensional advertising display is disclosed. The advertising display includes a frame, a first side, a second side and a third side that cooperatively form an advertising display, further including a first arm that is attached between the frame and the first side to pivot the first side either horizontally, vertically or a combination of both directions, a second arm that is attached between the frame and the second side to pivot the second side either horizontally, vertically or a combination of both directions and a third arm that is attached between the frame and the third side to pivot the third side either horizontally, vertically or a combination of both directions to optimize viewing of advertisements for the customer. Nonlimiting, but illustrative, mechanisms that can be utilized so that the arms can pivot the first side, the second side and/or the third side of the advertising display horizontally or vertically can include, but are not limited to, inner corrugated, flexible tubing, shims, a plurality of swivel joints, and so forth.

In an aspect of this present invention, a method for utilizing a three-dimensional advertising display is disclosed. The method includes displaying at least one electronic advertisement on an electronic panel display located on at least one side of an advertising display and displaying at least one printed advertisement on at least one side of the advertising display, wherein the advertising display includes a frame and the plurality of sides that cooperatively form the advertising display.

In another aspect of this present invention, a method for utilizing a three-dimensional advertising display is disclosed. The method includes displaying at least one electronic advertisement on an electronic panel display located on a first side of an advertising display, displaying a first printed advertisement on a second side of the advertising display and displaying a second printed advertisement on a third side of the advertising display, wherein the advertising display includes a frame, a first side, a second side and a third side that cooperatively form the advertising display.

In yet another aspect of this present invention, a method for utilizing a three-dimensional advertising display is disclosed. The method includes displaying a first electronic advertisement on an first electronic panel display located on a first side of a advertising display, displaying a second electronic advertisement on a second electronic panel display located on a second side of the advertising display and displaying a third electronic advertisement on a third electronic panel display located on a third side of the advertising display, wherein the advertising display includes a frame, the first side, the second side and the third side that cooperatively form the advertising display.

In still another aspect of this present invention, a method for utilizing a three-dimensional advertising display is disclosed. The method includes utilizing a plurality of members to form a frame for the advertising display that includes a frame, a first side, a second side and a third side that cooperatively forms an advertising display. An illustrative, but nonlimiting example of members can include angle brackets.

In another aspect of this present invention, a method for utilizing a three-dimensional advertising display is disclosed. The method includes utilizing a support mechanism, e.g., pipe or pole, attached to the frame to support the advertising display near a point-of-sale or a point-of-purchase, wherein the advertising display includes a frame and a first side, a second side and a third side that cooperatively form the advertising display.

In yet another aspect of this present invention, a method for utilizing a three-dimensional advertising display is disclosed. The method includes utilizing an attachment mechanism that secures an electronic panel display within a frame for the advertising display, wherein the advertising display includes the frame, a first side, a second side and a third side that cooperatively form the advertising display.

In another aspect of this present invention, a method for utilizing a three-dimensional advertising display is disclosed. The method includes utilizing a first arm that is attached between a frame and the first side to pivot the first side either horizontally, vertically or a combination of both directions, utilizing a second arm that is attached between the frame and the second side to pivot the second side either horizontally, vertically or a combination of both directions and utilizing a third arm that is attached between the frame and the third side to pivot the third side either horizontally, vertically or a combination of both directions to optimize viewing of the advertisements for the customer, wherein the advertising display includes the frame and a first side, a second side and a third side that cooperatively form the advertising display. Nonlimiting, but illustrative, methods of pivoting first side, the second side and the third side of the advertising display horizontally and/or vertically can include, but are not limited to, utilizing inner corrugated, flexible tubing, shims, a plurality of swivel joints, and so forth for the first arm, the second arm and the third arm.

In another aspect of the present invention, a three-dimensional advertising display is disclosed. The advertising display includes a polygonal frame with first, second and third sides cooperatively forming an advertising display. A brace is provided for mounting of the advertising display on a pole or the like and for mounting of an electronic panel display. The advertising display if provided with a plurality of display areas, one being on each of the first, second and third sides. A sleeve fits over the frame to form the display areas.

These are merely some of the innumerable illustrative aspects of this present invention and should not be deemed an all-inclusive listing. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a first alternative embodiment for an advertising display of the present invention;

FIG. 2 is front view of a second side of the first alternative embodiment for an advertising display of the present invention;

FIG. 3 is a top view of a frame and an electronic panel display of the first alternative embodiment for an advertising display of the present invention;

FIG. 4 is front view of a first side of the first alternative embodiment for the advertising display of the present invention;

FIG. 5 is a sectional view of the frame of the first alternative embodiment for the advertising display of the present invention taken along line 5-5, as shown in FIG. 4;

FIG. 6 is side view of the frame and the electronic panel display of the first alternative embodiment for the advertising display of the present invention, similar to the view shown in FIG. 2, from the perspective of facing the second side of the advertising display with the exception that the second side of printed advertising and the third side of printed advertising are removed from the frame for the advertising display of the present invention;

FIG. 7 is sectional view taken along line 6-6 as shown in FIG. 6, illustrating the mounting frame for the electronic panel display associated with the first alternative embodiment for the advertising display of the present invention;

FIG. 8 is an isolated side view of a second alternative embodiment of an arm for pivoting a side of the advertising display either horizontally, vertically or a combination of both directions that utilizes inner corrugated, flexible tubing;

FIG. 9 is an isolated side view of a third alternative embodiment of a fixed arm for pivoting a side of the advertising display either horizontally, vertically or a combination of both directions that utilizes the placement and/or removal of shims;

FIG. 10 is an isolated side view of a fourth alternative embodiment of an articulated arm for pivoting a side of the advertising display either horizontally, vertically or a combination of both directions that utilizes two (2) swivel joints;

FIG. 11 is an isolated side view of a fifth alternative embodiment of an articulated arm for pivoting a side of the advertising display either horizontally, vertically or a combination of both directions, that is similar to that shown in FIG. 10, with the exception that three (3) swivel joints are utilized instead of two (2) swivel joints;

FIG. 12 is a perspective view of a preferred embodiment of an advertising display;

FIG. 13 is a top plan view of the advertising display as shown in FIG. 12;

FIG. 14 is a bottom plan view of the display unit as shown in FIG. 12;

FIG. 15 is a perspective, exploded view of the advertising display of FIG. 12 with the outer sleeve removed to show the structural details of the frame of the advertising display;

FIG. 16 is a rear elevational view of the advertising display of FIG. 12;

FIG. 17 is a front view of a laminated printed advertisement associated with the present invention;

FIG. 18 is a front elevational view of the advertising display associated with the present invention illustrating a bracket for supporting an electronic display panel;

FIG. 19 is a bottom view of the advertising display associated with the present invention illustrating a mount for attaching the advertising display to a pole;

FIG. 20 is an electrical schematic of a series of electronic display panels display associated with the present invention connected to a single processor; and

FIG. 21 is a perspective view of an illustrative series of advertising displays utilized in an illustrative, but nonlimiting, environment of a grocery store checkout stand.

### DETAILED DESCRIPTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

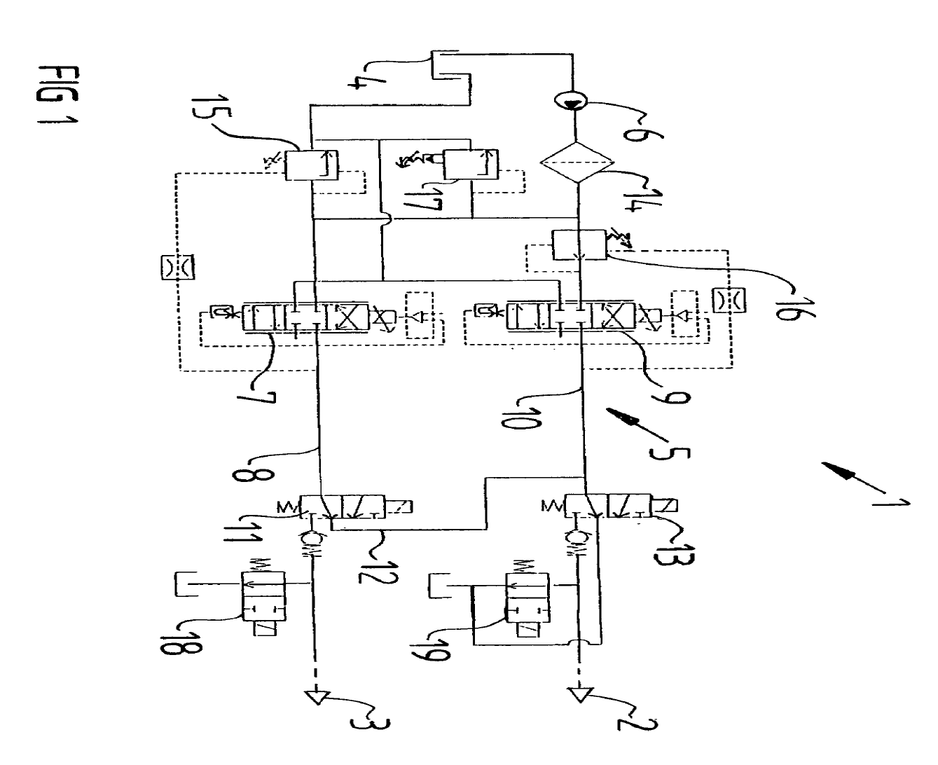

Referring now to the drawings, and initially to FIG. 1, which illustrates a first alternative embodiment of an advertising display, which is generally indicated by numeral 10. Although the advertising display 10 can include a plurality of sides, i.e., polygonal design, the preferred design is a three-sided triangular design. Preferably, at least one side of the three-sided triangular design is an electronic panel display 12, which is indicated as the first side 13 of the advertising display 10.

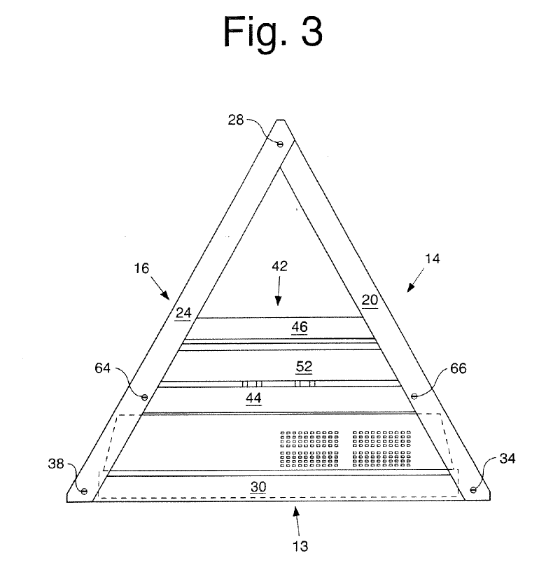

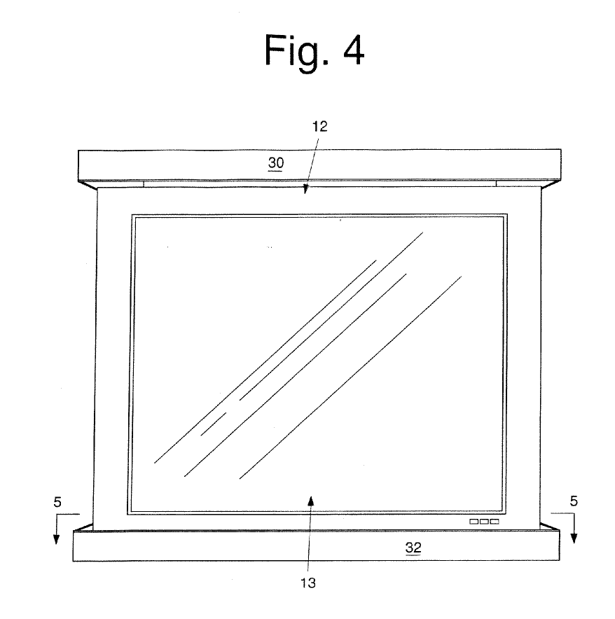

Optimally, all sides of the triangular design for the advertising display 10 may be electronic panel displays 12 so that the view shown in FIG. 4 would be replicated for all three sides 13, 14 and 16 of the advertising display 10. However, this is currently not the preferred embodiment solely due to cost considerations. The electronic panel display 12 is preferably a liquid crystal diode display (SGVA) with a display size of 1024 ×768 pixels, as is also shown in FIGS. 3 and 4. Although a liquid crystal diode display is preferred, cathode ray tube, plasma screen and other types of electronic panel displays 12 will suffice.

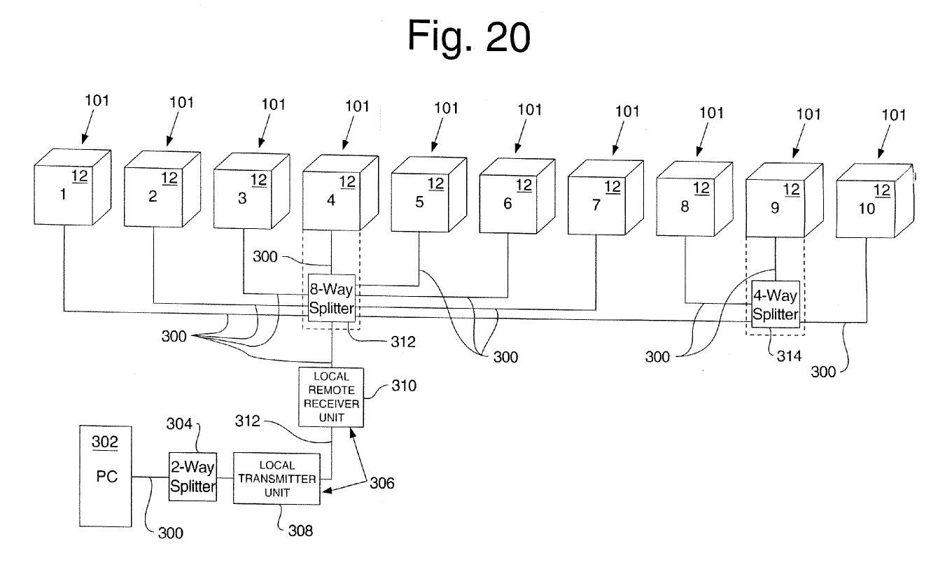

Electronic advertising can be supplied to the electronic panel display 12 from a wide variety of sources. The preferred mechanism for supplying electronic advertising to the electronic panel display 12 is by electrically connecting the electronic panel display 12 to a processor 302, as shown in FIG. 20, which receives advertising files and information via a data storage or a data transfer device such as utilizing a global computer network, e.g. Internet. The appropriate advertising is then downloaded by a particular processor 302 and is displayed within a particular panel on the electronic panel display 12. Each advertisement will be looped and reshown for a predetermined duration for a predetermined time interval that can flexibly altered from a remote location. Each advertisement can also include an audio portion. Each processor 302 can receive new downloaded information at a predetermined time interval to delete existing advertisements from the system and download new advertisements. A switch or push buttons can allow the customer viewing the display to go toggle back and forth between advertisements and replay those advertisements of particular interest. Advertisements can be used across the system or can be specific to a particular region or electronic panel display 12. A global computer system can provide additional information with searching capability for customers desiring more details about a particular product or service. This is fully described in International Patent Application No. PCT/US02/15377, entitled: A Method and System for Displaying Advertising on an Electronic Display Screen, which is incorporated herein by reference. International Patent Application No. PCT/US02/15377 was filed on May 15, 2002 and claims priority of U.S. Provisional pat. application ser. No. 60/291,065, which was filed on May 15, 2001. An example of an advertising instruction parameter file is listed below in Table 1:

TABLE 1

Ad Instruction Parameter
′transition type =
1-8 compass
direction 45 degree
clockwise 9 = zoom
99=random
′scroll = 1-4
clockwise 90
degrees 1-100 100 =
fastest
[FileName],
[seconds to
display], [transition
type], [order], [file
size],
[fileID], [scroll
direction 14],
′[speed of scroll(in
seconds across
panel)],
′[doNotShow
true<>0], [tag file],
[Fullscreen
true<>)],
[Static Order
true<>0],
[startDate],
[endDate],
[startDayOfWeek],
[endDayOfWeek],
[substituteAdName]
1 [seconds to
display] seconds ad
will run
2 [transition type]
′transition type = 1-8
compass direction
45 degree
clockwise 9 = =
zoom 99=random
3 [order] if this is
omitted or
duplicated the
program will fit it in
unless Static Order
4 [file size] actual
file size - checks
against existing or
downloaded - if
different the file is
deleted
5 [fileID] Not used
6 [scroll direction
1-4]
7[speed of scroll]
seconds it takes for
a marquee to scroll
across screen
8[donotshow] will
not show file (used
or tag and
substitute)
9[tagfile] file to
show if third button
pressed
10[FullScreen
true<>0] shows the
entire screen - (over
marquee)
11[Static order
true<>0] forces
order if listed to be
enforced
12[startDate[(,
startDate,
startDate)] *
13[endDate](,
endDate, endDate)] *
14[startDayOfWeek[(,
startDayOfWeek,
startDayOfweek)] *
15[endDayOfWeek[(,
end Dayofweek,
endDayOfWeek)] *
16[substituteAdName]
ad to show if this
one doesn't [symbol]
substituteAdName
must be separate
file entry [symbol]
(donotshow =1
will stop ad from
being in mix by
itself)
″* NOTE 1. Multiple
dates, times, days
can be shown by
separating by
semicolons,
i.e., . . .″,
10/20/03; 11/10/03, 11/02/03; 11/20/03
the above ad will
run 10/20/03 thru
11/02/03 and again
11/10/03 thru
11/20/03
2. start and ends
must have
corresponding
entries - ends
before start = ignore
entry
3. days show in
constraints of dates
and or times
4. times shown
without dates show
every day unless
days dictate
differently

Another method of electronically providing electronic advertising to the electronic panel display 12 also includes videotape players and DVD players and virtually any other type of device that can store visual information electronically for display on an electronic panel display 12. Also, satellite and wireless technology can be utilized. An example of using satellite technology with a global computer network, e.g., Internet is disclosed in U.S. Pat. No. 6,105,060, entitled: “System for Providing Global Portable Internet Access Using Low Earth Orbit Satellite and Satellite Direct Radio Broadcast System,” which issued Aug. 15, 2000 to Rothblatt and is incorporated herein by reference. The advertisements can be sent by satellite and then decoded locally with a receiver associated with the electronic panel display 12. Each receiver can decode the appropriate advertising associated with a particular electronic panel display 12. The transmission of video content via satellite is disclosed in U.S. Pat. No. 6,111,611 issued to Ozkan et al. on Aug. 29, 2000, which is incorporated herein by reference.

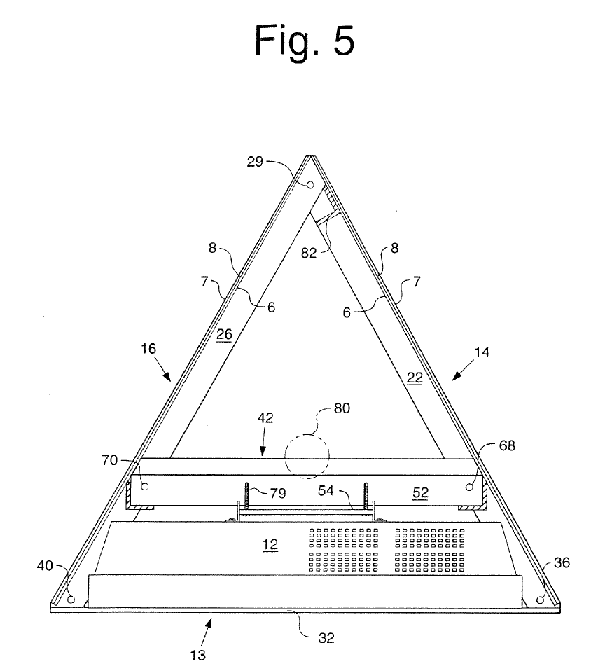

The second side 14 of the advertising display 10 and the third side 16 of the advertising display 10, as best illustrated by the second side 14 of the advertising display 10 as shown in FIG. 1, is preferably a laminated printed advertisement 5 positioned against a back frame 6. As an alternative to the laminated printed advertisement 5, as shown in FIG. 5, would include a first layer of transparent material 7, e.g., plastic. An example of a plastic would include a resinous material such as PLEXIGLAS®, positioned adjacent to the back frame 6 so that a printed paper advertisement 8 could be inserted in between the back frame 6 and the first layer of transparent material 7. PLEXIGLAS® is a registered trademark of Atofina Corporation, having a place of business at 4-8 Cours Michelet La Defense 10, F92091 Paris La Defense Cedex, French Republic. The first layer of transparent material 7 allows the viewing by the customer of a standard printed paper advertisement 8 that can be easily replaced from time-to-time while providing protection to the printed paper advertisement 8. A wide variety of materials can be utilized for the back frame 6 such as metal, plastic, wood, and so forth.

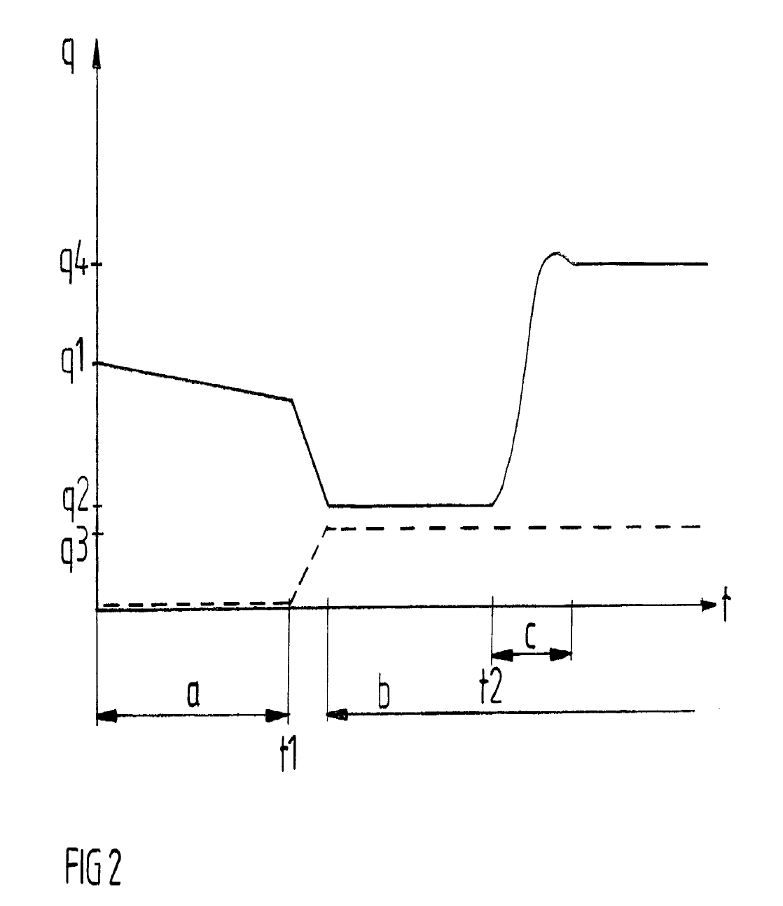

As shown in FIGS. 2, 3 and 5, the second side 14 of the advertising display 10 is preferably supported by a first, upper member 20 and a first, lower member 22. Also, as shown in FIGS. 3 and 5, the third side 16 of the advertising display 10 is preferably supported by a second, upper member 24 and a second, lower member 26. Moreover, as shown in FIGS. 1, 3 and 5, the first side 13 of the advertising display 10 is preferably supported by a third, upper member 30 and a third, lower member 32. The members 20, 22, 24, 26, 30 and 32 can be made of virtually any material, e.g., wood, plastic, and so forth, however, the preferred material is metal, e.g., aluminum. The members 20, 22, 24, 26, 30 and 32 are preferably angle brackets each with a preferred width of 1.0 inches (2.54 centimeters).

Preferably, for simplicity and cost considerations, the second side 14 of the advertising display 10 and the third side 16 of the advertising display 10 are fixedly attached to each other. A wide variety of attachment mechanisms may suffice including mechanical hardware, thermal bonding, e.g., welding or brazing, and adhesives. In the illustrative, but nonlimiting example, the first, upper member 20 and the second, upper member 24 are attached by a first threaded bolt and nut combination 28, as shown in FIG. 3. The first, lower member 22 and the second, lower member 26 are attached by a second threaded bolt and nut combination 29, as shown in FIG. 5.

Moreover, again preferably for simplicity and cost considerations, the first side 13 of the advertising display 10 and the second side 14 of the advertising display 10 are fixedly attached to each other. A wide variety of attachment mechanisms may suffice including mechanical hardware, thermal bonding, e.g., welding or brazing, and adhesives. In the illustrative, but nonlimiting example, the first, upper member 20 and the third, upper member 30 are attached by a third threaded bolt and nut combination 34, as shown in FIG. 3. The first, lower member 22 and the third, lower member 32 are attached by a fourth threaded bolt and nut combination 36, as shown in FIG. 5.

Furthermore, again preferably for simplicity and cost considerations, the first side 13 of the advertising display 10 and the third side 16 of the advertising display 10 are fixedly attached to each other. For this present invention, a wide variety of attachment mechanisms may suffice including mechanical hardware, thermal bonding, e.g., welding or brazing, and adhesives. In the illustrative, but nonlimiting example, the second, upper member 24 and the third, upper member 30 are attached by a fifth threaded bolt and nut combination 38, as shown in FIG. 3, and the second, lower member 26 and the third, lower member 32 are attached by a sixth threaded bolt and nut combination 40, as shown in FIG. 5.

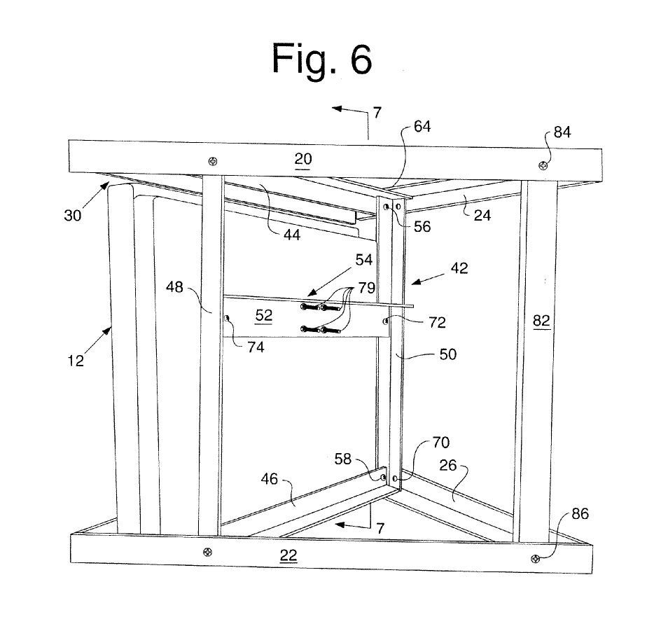

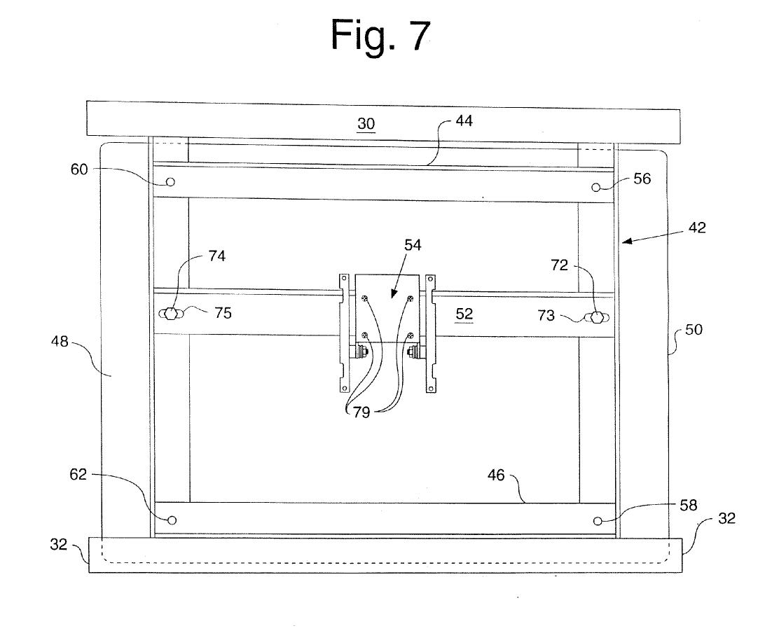

Referring now to FIGS. 3, 5, 6 and 7, the electronic panel display 12 is preferably mounted within the advertising display 10 on a support frame that is generally indicated by numeral 42. As best illustrated in FIGS. 6 and 7, this includes an upper horizontal support member 44, a lower horizontal support member 46, a first vertical support member 48 and a second vertical support member 50. There is a center support member 52 that attaches to a typical mounting arm 54 for the electronic panel display 12. The upper horizontal support member 44, the lower horizontal support member 46, the first vertical support member 48 and the second vertical support member 50 are preferably in the form of angle brackets and can be made of virtually any material, e.g., wood, plastic, and so forth. However, the preferred material is metal, e.g., aluminum. The width for the upper horizontal support member 44, the lower horizontal support member 46, the first vertical support member 48 and the second vertical support member 50 can vary but is preferably 1.0 inch (2.54 centimeters).

In the illustrative, but nonlimiting preferred example, the upper horizontal support member 44 and the second, vertical support member 50 are attached by an eighth threaded bolt and nut combination 56 and the lower horizontal support member 46 and the second, vertical support member 50 are attached by a ninth threaded bolt and nut combination 58, as shown in FIGS. 6 and 7.

In the illustrative, but nonlimiting preferred example, the upper horizontal support member 44 and the first, vertical support member 48 are attached by a tenth threaded bolt and nut combination 60 and the lower horizontal support member 46 and the first vertical support member 48 are attached by an eleventh threaded bolt and nut combination 62, as shown in FIG. 7.

The first vertical support member 48 and the first, upper member 20 are attached by a thirteenth threaded bolt and nut combination 66, as shown in FIG. 3, and the first vertical support member 48 and the second, lower member 26 are attached by a fourteenth threaded bolt and nut combination 68, as shown in FIG. 5. The second vertical support member 50 and the second, upper member 24 are attached by a twelfth threaded bolt and nut combination 64, as shown in FIG. 3, and the second vertical support member 50 and the second, lower member 26 are attached by a fifteenth threaded bolt and nut combination 70, as shown in FIG. 5.

The support frame 42 also includes an adjustable center support mounting arm 52 that is attached to the second, vertical support member 50 through a sixteenth nut and bolt combination 72 located within a first oval groove 73 and the adjustable center support mounting arm 52 is attached to the first, vertical support member 48 through a seventeenth nut and bolt combination 74 located within a second oval groove 75, as shown in FIG. 7. The adjustable center support-mounting arm 52 is attached to a conventional mounting bracket 54 for an electronic panel display 12. The conventional mounting bracket 54 is attached to the adjustable center support mounting arm 52 by a plurality of nut and bolts 79, e.g., four (4). A nonlimiting example of a conventional mounting bracket 54 for an electronic panel display 12 would be that manufactured by NEC-Mitsubishi Electronics Display of America, Inc. having a place of business at 1250 North Arlington Heights Road, Suite 500, Itasca, Illinois 60143-1248. The adjustable center support mounting arm 52 is preferably in the form of an angle bracket and can be made of virtually any material, e.g., wood, plastic, and so forth. However, the preferred material is metal, e.g., aluminum. The width of the adjustable center support-mounting arm 52 can vary but is preferably 1.5 inches (3.81 centimeters).

There is a main vertical support member 82 that is secured to the first, upper member 20 by an eighteenth nut and bolt combination 84 and the main vertical support member 82 is secured to the first, lower member 22 by a nineteenth nut and bolt combination 86, as shown in FIG. 6.

There is a center pole 80 that is secured to the aforementioned support frame 42. This center pole 80 can attach to square tubing or a standard threaded pipe such as a 1.5 inch (3.81 centimeters) National Pipe Thread, as shown in FIG. 5.

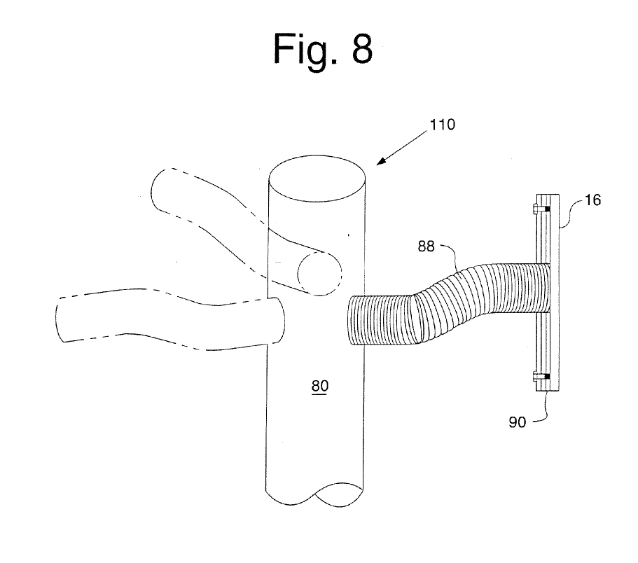

Referring now to FIG. 8, which illustrates a second alternative embodiment of a side support, which is generally indicated by numeral 110, where the third side 16 of the advertising display 10 is connected to the center pole 80 by an arm 88. The arm 88 is preferably inner corrugated, flexible tubing. A nonlimiting, illustrative example of this type of arm 88 utilizing inner corrugated, flexible tubing is utilized by a STANRITE® studio easel light that is manufactured by Testrite Instrument Co., Inc., having a place of business at 135 Monroe Street, Newark, North Carolina 07105. Use of this same type of arm 88 can be replicated for the first side 13 and can be replicated for the second side 14 of the advertising display 10. This arm 88 allows the third side 16 of the advertising display 10 to be pivoted both vertically and horizontally to maximize visual impact on the customer depending on the environment. Preferably, any gaps between the sides 13, 14 and 16 of the advertising display 10 can be covered with filler material 90, e.g., ribbed, accordion, plastic material.

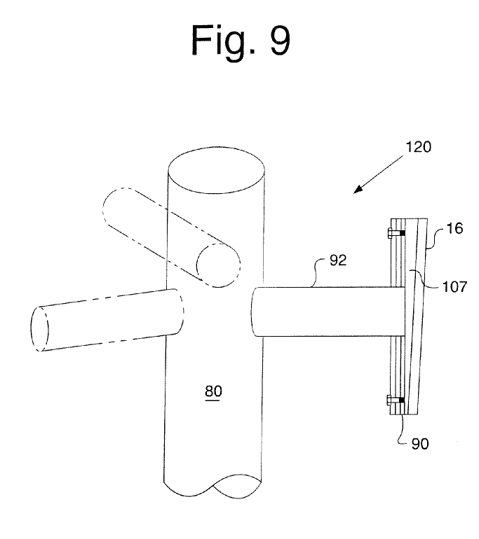

Referring now to FIG. 9, which illustrates a third alternative embodiment of a side support that is generally indicated by numeral 120, where the third side 16 of the advertising display 10 is connected to the center pole 80 by a fixed arm 92. Use of this same type of fixed arm 92 can be replicated for the first side 13 and can be replicated for the second side 14 of the advertising display 10. This fixed arm 92 does not flex, however, shims 107 may be added or removed to pivot the third side 16 both vertically or horizontally or a combination of both directions to maximize visual impact on the customer depending on the environment. As with arm 88, any gaps between the panels 13, 14 and 16 can be covered with filler material 90, e.g., ribbed, accordion, plastic material.

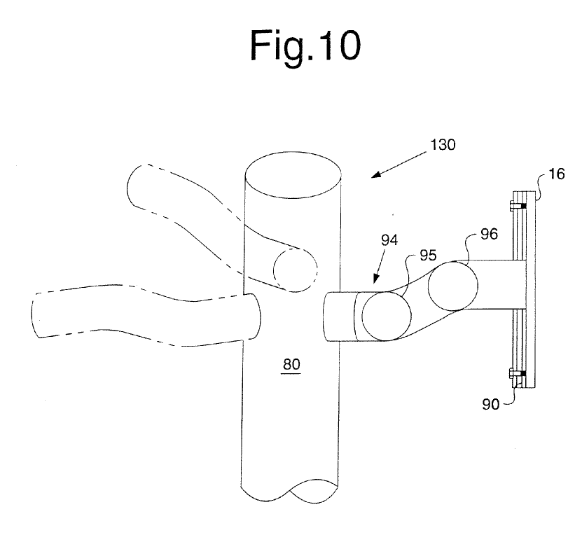

Referring now to FIG. 10, which illustrates a fourth alternative embodiment of a side support which is generally indicated by numeral 130, where the third side 16 of the advertising display 10 is connected to the center pole 80 by a first articulated arm 92. Use of this same type of first articulated arm 94 can be replicated for the first side 13 and can be replicated for the second side 14 of the advertising display 1 0. This first articulated arm 94 allows the third side 16 of the electronic panel display 12 to pivot both horizontally and vertically due to a first swivel joint 95 and a second swivel joint 96 to maximize visual impact on the customer depending on the environment. Optionally, any gaps between the panels 13, 14 and 16 can be covered with filler material 90, e.g., ribbed, accordion, plastic material. Illustrative, but nonlimiting, examples of swivel joints 95 and 96 include those manufactured by Rotary Systems, Inc., having a place of business at 1036 McKinley Street, Anoka, Minnesota 55303.

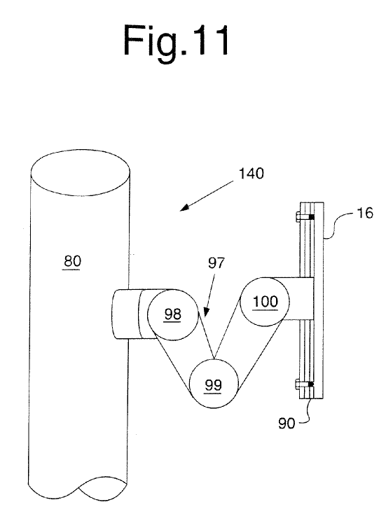

Referring now to FIG. 11, which illustrates a fifth alternative embodiment of a side support which is generally indicated by numeral 140, where the third side 16 of the advertising display 10 is connected to the center pole 80 by a second articulated arm 97. Use of this same type of second articulated arm 97 can be replicated for the first side 13 and can be replicated for the second side 14 of the advertising display 10. This second articulated arm 97 allows the third side 16 of the electronic panel display 12 to pivot both horizontally and vertically due to a third swivel joint 98, a fourth swivel joint 99 and a fifth swivel joint 100 to maximize visual impact on the customer depending on the environment. Optionally, any gaps between the panels 13, 14 and 16 can be covered with filler material 90, e.g., ribbed, accordion, plastic material. Illustrative, but nonlimiting, examples of the third, the fourth and the fifth swivel joints 98, 99 and 100 include those manufactured by Rotary Systems, Inc., having a place of business at 1036 McKinley Street, Anoka, Minnesota 55303.

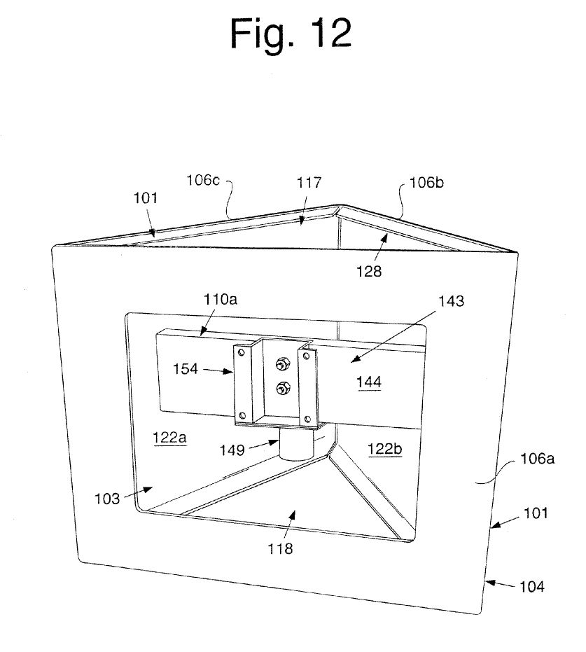

The preferred embodiment of the advertising display of the present invention is generally indicated by numeral 101 in FIG. 12. The advertising display 101 includes an interior support frame 103 and an exterior shell 104. As shown, the shell 104 is sleeved onto the support frame 103 and is selectively movable relative to the support frame 103 in a longitudinal direction. The shell 104 is comprised, in the illustrated embodiment, of a plurality of display panels 106A, 106B and 106C which in number corresponds to the number of sides of the advertising display 101. In the illustrated structure, the advertising display 101 has three sides; however, it is to be understood that numerous other sides may be present but the preferred embodiment includes three sides. The panels or sides 106A, 106B and 106C are preferably formed from material that is both resilient and break-resistant material. An illustrative, but nonlimiting example, can include a polymeric material. A polymeric material can include a moderately expanded, rigid polyvinyl chloride (PVC) material with a high gloss satin finish. An example of this type of material includes SINTRA® available from Alcan Composites, USA Inc. located at 208 W. 5th Street, Benton, Kentucky 42025-0507.

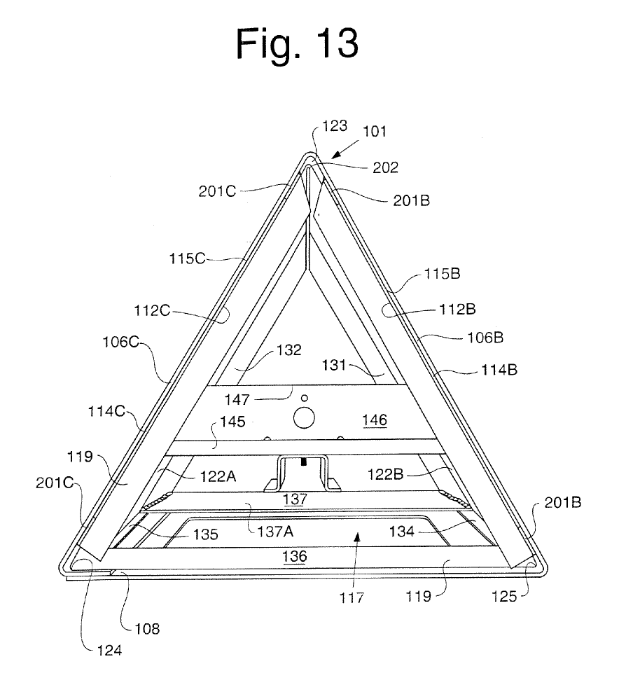

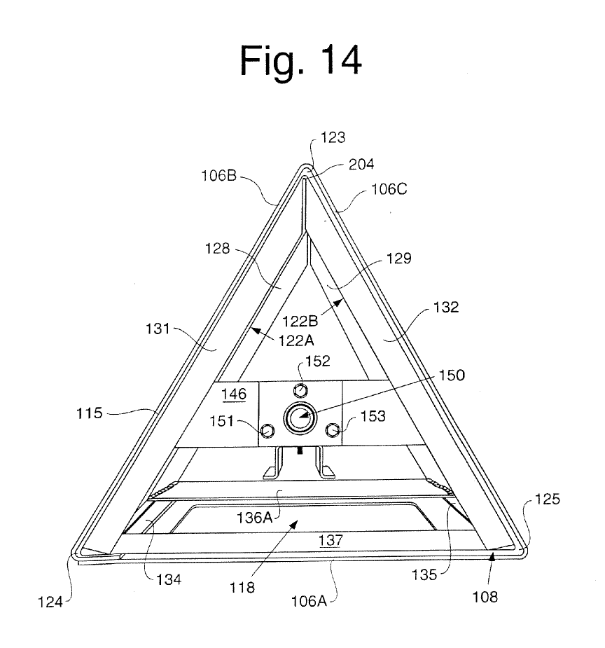

The shell 104 may be formed by any suitable method such as extrusion or may be formed from a flat panel and configured into a geometric shape, e.g., triangular cross-sectional shape, just by bending at the corners between the panels 106A, 106B and 106C and then joining the overlapping portions 108 as shown in FIGS. 13 and 14. This joining can be accomplished by a variety of chemical, thermal and mechanical processes, however, the preferred process includes adhesives. The adhesives utilized can be any of a wide variety of adhesives including, but not limited to, polyvinyl chloride (PVC) glues.

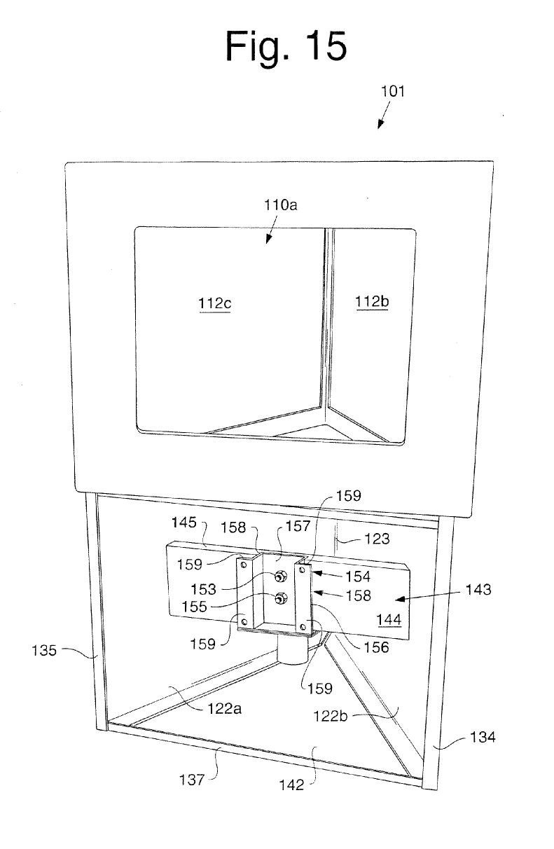

The transverse cross-sectional shape of the shell 104 is preferable generally uniform along the height of the shell 104 making it suitable for molding as by extrusion. As shown, each of the panels 106A, 106B and 106C, have a display opening 110A, 110B and 110C, respectively, therein. This is best shown in FIGS. 12, 15 and 16. The display opening 110A is a through opening and provides visual exposure to the screen of an electronic display panel 12, which is previously described above. Also, as best shown in FIG. 15, the shell 104 is provided with backing members 112B and 112C, which are secured behind opening 110B and 110C respectively. The backing members 112B and 112C are suitably secured to the panels 106B and 106C. This securing of the backing members 112B and 112C to the panels 106B and 106C can be accomplished by a variety of chemical, thermal and mechanical processes, however, the preferred process includes adhesives.

As with the panels or sides 106A, 106B and 106C, the backing members 112B and 112C are also preferably formed from material that is both resilient and break-resistant material. An illustrative, but nonlimiting example, can include a polymeric material. A polymeric material can include a moderately expanded, rigid polyvinyl chloride (PVC) material. An example of this type of material includes SINTRA® available from Alcan Composites, USA Inc. located at 208 W. 5th Street, Benton, Kentucky 42025-0507. Preferably the backing members 112B and 112C may be translucent or transparent for backlighting with a light, not shown.

A gap 114B, 114C, as shown in FIG. 13, is provided preferably at the top of each panel 106B, 106C to allow the insertion of a laminated printed advertisement 5 into each pocket 115B, 115C formed between a panel 106B, 106C and the respective backing 112B, 112C. Preferably, a u-shaped frame 201B, 201C, as shown in FIGS. 13 and 14, can be utilized to support the laminated printed advertisement 5 and create the pocket 115B, 115C and well as the gap 114B, 114C. This u-shaped frame 201 can be attached to the panels 106B, 106C or made an integral part thereof. One illustrative, but nonlimiting, example of the type of material that can be utilized to create the frame is polymeric material. A polymeric material can include a moderately expanded, rigid polyvinyl chloride (PVC) material. An example of this type of material includes SINTRAgfix# available from Alcan Composites, USA Inc. located at 208 W. 5th Street, Benton, Kentucky 42025-0507, which is exactly like the previously described moderately expanded, rigid polyvinyl chloride (PVC) material sold under the trademark SINTRA® with a high tack adhesive on one side. However, the unshaped frame 201B, 201C can be attached to the panels 106B, 106C by a variety of chemical, thermal and mechanical processes with only the preferred process including adhesives.

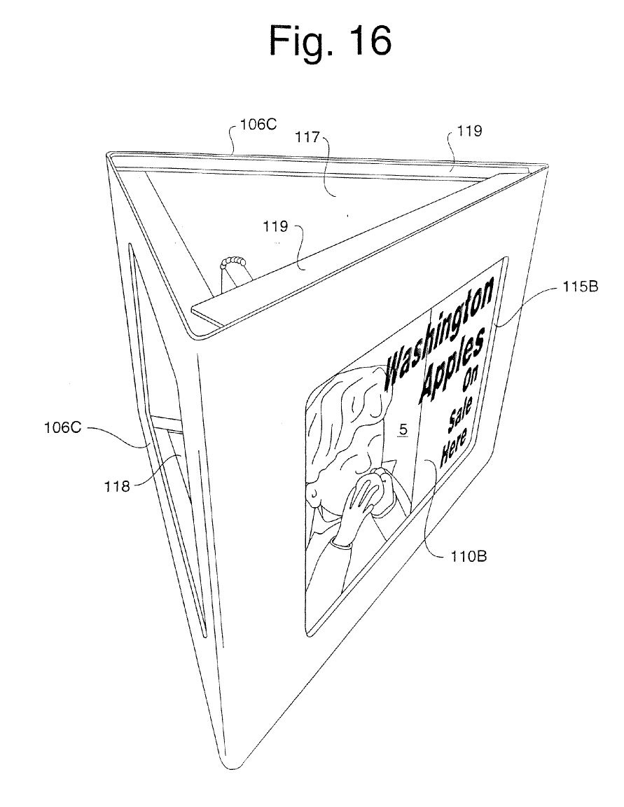

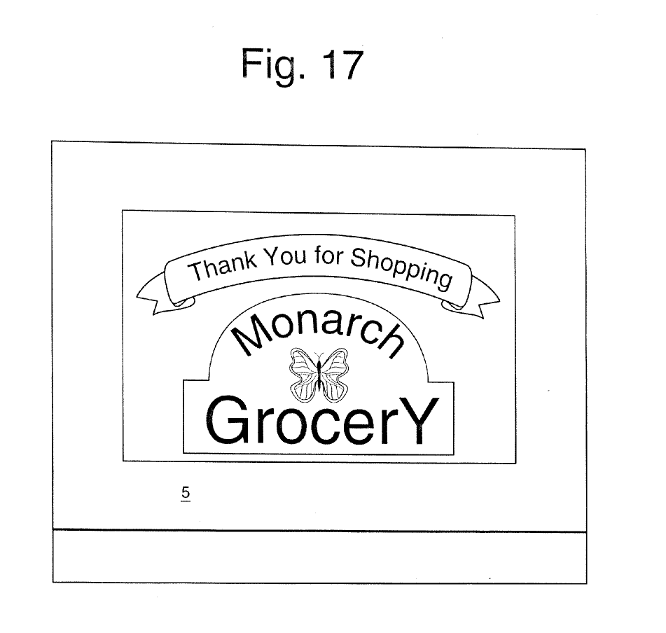

The printed advertisement 5 as also shown in FIG. 17, is thus viewable through a respective display opening 110B, 110C and yet is positively removably retained within a respective pocket 115B, 115C by having the advertisement 5 larger than the respective opening 110B, 110C, as shown in FIGS. 13 and 16. Both of the opposite ends 117, 118 of the shell 104 are open as shown in FIGS. 12 and 16. However, as best seen in FIG. 13, a plurality of stops 119 project into the interior of the shell 104 for engagement with an upper portion of the interior support frame 103 to limit longitudinal movement of the shell 104 relative to the support frame 103. The stops 119 are in the shape of a shoulder attached to each of the backing members 112B, 112C and preferably may be integrally formed therewith.

As shown in FIGS. 13-15, for the illustrative triangular embodiment, the interior support frame 103 has an exterior shape similar to the interior shape of the shell 104 to permit the shell 104 to be slidably received thereover. An illustrated, but nonlimiting, interior support frame 103 can include two wall members 122A and 122B that could be formed from one solid piece of metal that is formed at an angle, e.g., 60 degrees. A third side includes an upper support member 136 and a lower support member 137. The upper support member 136 and the lower support member 137 are preferably flanged. The interior support frame 103 can be made of a wide variety of materials such as metals, composites and plastics. However, the preferred material is lightweight aluminum.

The two wall members 122A, 122B, the upper support member 136 and the lower support member 137 are preferably joined at corners 123, 124 and 125, respectively, as shown in FIGS. 13 and 14. The corners 123, 124 and 125 are preferable generally parallel to one another. The wall members 122A and 122B are shown as being similar in construction and joined at the corner 123. Each of the two wall members 122A and 122B have an inwardly turned top flange 128, 129, respectively, and a bottom flange 131, 132, respectively, to help provide resistance to bending of the respective wall members 122A and 122B. It is preferred that the wall members 122A and 122B be made out of a single piece of material wherein the corner 123 is a integral portion of both of the walls and can be formed by simply bending a sheet of material after forming a top notch 202 between the top flanges 128 and 129, as shown in FIG. 13, and forming a bottom notch 204 between the bottom flanges 128 and 129, as shown in FIG. 14.

As shown in FIGS. 13 and 14, the wall member 122A has an inwardly turned longitudinally extending flange 134 and the wall member 122B has a similarly formed flange 135. The flanges 134, 135 preferably may be an integral part of the respective wall members 122A and 122B and formed by bending or turning inwardly of the material comprising the walls to provide structural resistance. The flanges 134, 135 may also be separate components fixedly attached thereto by welding, adhesives or other suitable means of attachment.

The upper support member 136 and the lower support member 137 are preferably positioned at the top and bottom respectively of the panel 106A, and are in the form of angle members each with a respective flange 136A and 137B, respectively, that are parallel to one another forming a face for the panel 106C. The flanges 136A, 136B may also be separate components fixedly attached thereto by welding, adhesives or other suitable means of attachment, as shown in FIG. 2.

As shown in FIGS. 12 and 16, the interior of the support frame 103 is generally hollow. It is preferred that the support frame 103 have opposite top and bottom ends 117, 118 respectively that are open to provide access to the interior of the support frame 103 for example to secure the support frame 103 to the center pole 80, as shown in FIG. 5, and for facilitating attachment of the electronic panel display 12 to the support frame 103.

As shown in FIG. 12, a support brace 143 is secured to and extends between the wall members 122A and 122B. The support brace 143, which is generally described as a unshaped channel, includes an upstanding wall 144 with a right angle flange 145 at the top extending away from the panel 106A, as shown in FIG. 15. As shown in FIG. 13, there is an inturned flange 146 at the bottom of the wall 144, which extends away from the panel 106A and generally parallel to the flange 145. At the rear edge 147 of the flange 146 there is an upturned flange 147 that is generally parallel to the wall 144.

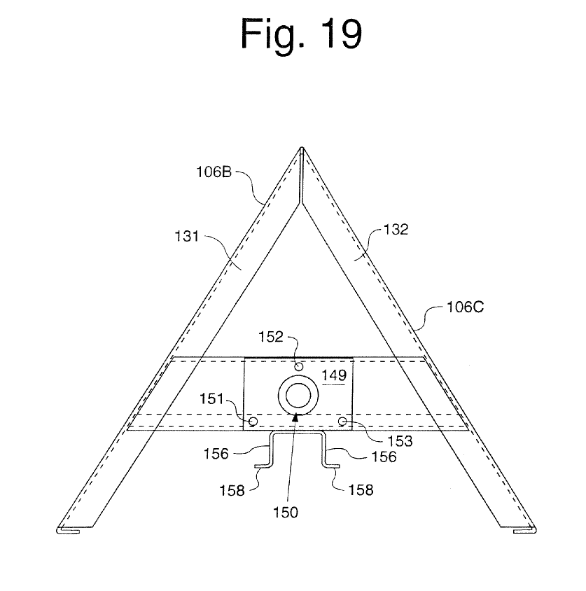

A mount 149 is secured to the inturned flange 146 and has a threaded hole 150 for mounting of the display 101 on a pole 80. Although a threaded cooperative engagement between the pole 80 and mount 149 is shown, other forms of mounting may be provided for example a set screw may be provided and a hole may be a blind hole to limit longitudinal movement of the pole 80 into the mount 149. The mount 149 may be secured to the support brace 143 by a variety of chemical, thermal and mechanical processes with only the preferred process including utilizing cooperatively interengaging nut and bolt combinations 151, 152 and 153, as shown in FIGS. 14, 18 and 19 may be used. The longitudinal axis of the threaded hole 150 is generally vertical when the advertising display 101 is in its mounted position for display.

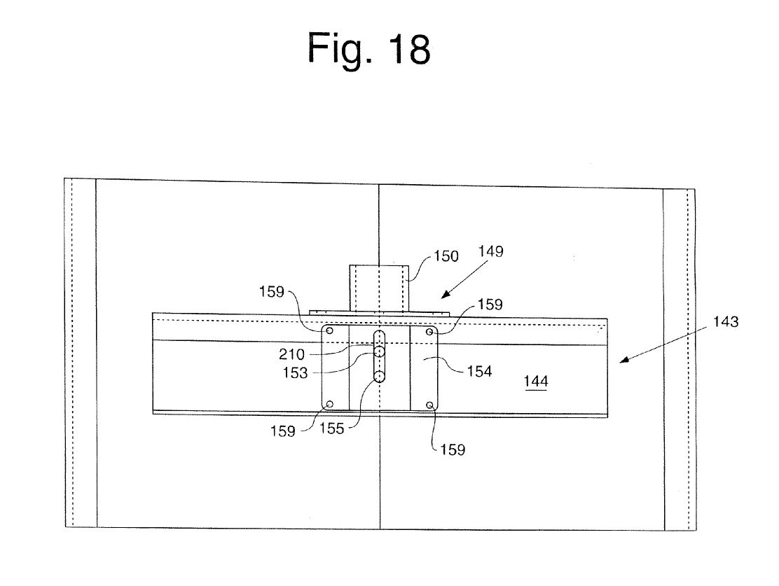

A bracket 154 for mounting the electronic panel display 12 can be secured to the wall 144 of the support brace 143 by a variety of chemical, thermal and mechanical processes with the preferred process including utilizing cooperatively interengaging nut and bolt combinations 153 and 155 that can also include washers. There is preferably an oval groove 210 in the upstanding wall 144 so that the position of the bracket 154 can vary longitudinally within the advertising display 10 as shown in FIGS. 15 and 18. As shown, the bracket 154 generally in the form of a U shaped channel with opposed and outwardly projecting flanges 156. The bracket 154 has a bight portion 157 with legs 158 extending from each of the longitudinal side edges of the bight 157. The flanges 156 in turn project from the free end of the legs 158. The flanges 156 may be provided with apertures 159 for the receipt of suitable fasteners such as screws for attaching the electronic panel display 12 to the bracket 154 and hence to the advertising display 101. The display screen of the electronic display 12 is exposed to a consumer through an opening in the panel 106A. The bracket 154 for mounting the electronic panel display 12 preferably conforms to a standard set forth by the Video Electronics Standards Association. The standard for mounting holes at 2.95 inches (75 millimeters) by 2.95 inches (75 millimeters) is adaptable for most electronic panel displays 12.

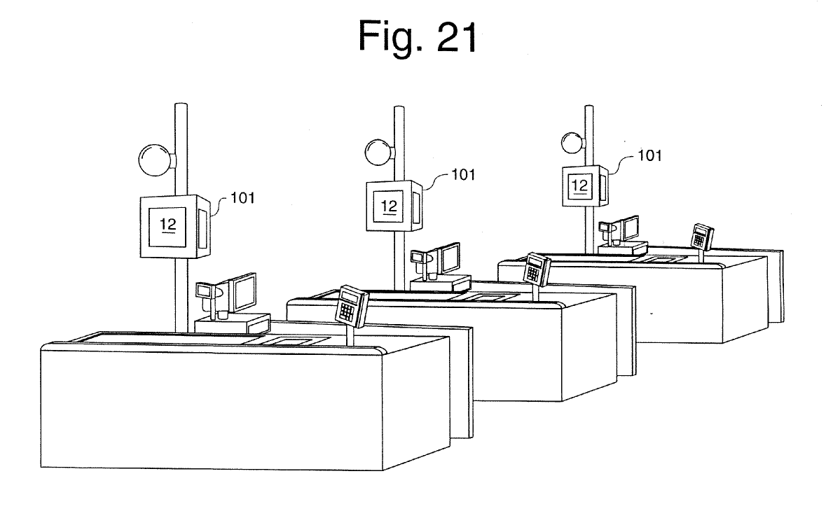

The preferred electrical wiring schematic for multiple store advertising displays 101 includes connecting a number of electronic panel displays 12 that are associated with advertising displays 10 throughout the desired establishment, e.g., each checkout lane in a grocery store. In the preferred, illustrative but nonlimiting embodiment, the processor 302 is electrically connected via VGA cable 300 to a two-way splitter 304 then to a video extender kit 306 via VGA cable 300. The video extender kit 306 allows an extension of the distance between the processor 302 and the electronic panel displays 12 by hundreds of feet. This is accomplished by a local transmitting unit 308 and local remote receiving unit 310 connected by standard Category Five (5) twisted pair Ethernet cable 312. The VGA cable 300 provides for transmission of video/data signals having a wide bandwidth. In this illustrative embodiment, there is both an eight-way splitter 312 and a four-way splitter 314 to provide the video to the illustrative ten (10) electronic panel displays 12. An example of a perspective view of a number of checkout lanes each having an advertising display 101 with a preferred, but not necessary, electronic panel display 12 is shown in FIG. 21.

Although a preferred embodiment of an advertising display and method of use has been illustrated in the accompanying drawings and described in the foregoing detailed description, it is understood that the invention is not limited to the embodiment disclosed, but is capable of numerous rearrangements, modifications and substitutions without departing from the spirit for the invention as set forth and defined by the following claims.

1. An advertising display comprising:
a plurality of display panels including at least one first display panel, at least one second display panel and at least one third display panel, the plurality of display panels cooperatively forming a polygonal display with at least one of the plurality of display panels having an electronic panel display exposed for display of electronic visual advertising information thereon and any remaining display panels of the plurality of display panels can display visual advertising information, wherein the at least one first display panel, the at least one second display panel and the at least one third display panel are facing generally in different directions; and
a source of electronic advertising information operably associated with the at least one electronic display panel for displaying the electronic visual advertising information on the at least one electronic panel display.

2. The advertising display as set forth in claim 1, wherein the visual advertising information includes at least one printed advertisement.

3. The advertising display as set forth in claim 1, further including a support device associated with the plurality of display panels for supporting the plurality of display panels in an elevated position in a retail outlet.

4. The advertising display as set forth in claim 3, wherein at least one of the display panels of the plurality of display panels is moveable relative to the support device.

5. The advertising display as set forth in claim 3, wherein at least one of the display panels of the plurality of display panels being moveable relative to at least one of the other display panels of the plurality of display panels.

6. The advertising display as set forth in claim 1, further including a support frame that is operatively connected to the plurality of display panels.

7. The advertising display as set forth in claim 6, wherein the support frame includes a plurality of angle brackets.

8. The advertising display as set forth in claim 6, wherein the support frame includes a plurality of wall members.

9. The advertising display as set forth in claim 8, wherein the plurality of wall members each include a top flange portion located on the top of each of the plurality of wall members and a bottom flange portion located on the bottom of each of the plurality of wall members.

10. The advertising display as set forth in claim 6, further including at least one attachment mechanism connected to the at least one electronic panel display and connected to the support frame.

11. An advertising display comprising:
a plurality of display panels including at least one first display panel, at least one second display panel and at least one third display panel, the plurality of display panels cooperatively forming a polygonal display with at least one of the plurality of display panels having an electronic panel display exposed for display of electronic visual advertising information thereon and any remaining display panels of the plurality of display panels can display visual advertising information, wherein the at least one first display panel, the at least one second display panel and the at least one third display panel are facing generally in different directions and mounted within a support frame;
a source of electronic advertising information operably associated with the at least one electronic display panel for displaying the electronic visual advertising information on the at least one electronic panel display; and at least one first arm that is attached between the support frame and the at least one first display panel to pivot the at least one first display panel in at least one direction, at least one second arm that is attached between the support frame and the at least one second display panel to pivot the at least one second display panel in at least one direction, and at least one third arm that is attached between the support frame and the at least one third display panel to pivot the at least one third display panel in at least one direction to optimize viewing of advertisements.

12. The advertising display as set forth in claim 11, wherein at least one first arm, at least one second arm, and the at least one third arm utilizes components selected from the group consisting of flexible tubing, shims, and at least one swivel joint.

13. The advertising display as set forth in claim 1, wherein the source of the electronic advertising information for the at least one electronic display panel is digitally stored.

14. The advertising display as set forth in claim 1 wherein the source of the electronic advertising information for the at least one electronic display panel is from a global computer network.

15. The advertising display as set forth in claim 1, further including a plurality of the advertising displays connected to the source of electronic advertising information, wherein the plurality of electronic advertising displays are positioned in a spaced apart relationship.

16. The advertising display as set forth in claim 15, wherein the source of advertising information including digitally stored advertising information provided to the plurality of advertising displays, wherein the plurality of advertising displays are operatively connected to at least one splitter, wherein the at least one splitter is operatively connected to at least one video receiver, wherein the at least one video receiver is operatively connected to at least one video transmitter, wherein the at least one video transmitter is operatively connected to at least one processor that utilizes the digitally stored advertising information.

17. The advertising display as set forth in claim 6, further including an exterior shell, having at least one opening therein, and positioned over at least one backing member, wherein the at least one backing member is positioned adjacent to the support frame and the exterior shell and the at least one backing member are operatively connected together to form a pocket for receiving a removable printed advertisement so that the printed advertisement can be viewed through the at least one opening in the exterior shell.

18. The advertising display as set forth in claim 17, wherein the exterior shell and the at least one backing member includes polymeric material.

19. The advertising display as set forth in claim 18, wherein the polymeric material includes moderately expanded, rigid polyvinyl chloride material.

20. The electronic advertising display as set forth in claim 7, wherein the at least one backing member is attached to a unshaped frame, wherein the unshaped frame is attached to the exterior shell and wherein the backing member further includes at least one stop for limiting longitudinal movement of the exterior shell in relationship to the support frame.

21. A method of displaying visual advertising information in at least three different directions comprising:
providing a plurality of display panels including at least one first display panel, at least one second display panel and at least one third display panel, the plurality of display panels cooperatively forming a polygonal display with at least one of the plurality of display panels having an electronic panel display exposed for display of electronic visual advertising information thereon and any remaining display panels of the plurality of display panels can display visual advertising information, wherein the at least one first display panel, the at least one second display panel and the at least one third display panel are facing generally in different directions;
displaying electronic advertising information on the at least one electronic panel display; and
displaying printed advertisements on the remaining display panels of the plurality of display panels.

22. The method as set forth in claim 21, further includes positioning the plurality of display panels in an elevated position in a retail outlet by utilizing a support device associated with the plurality of display panels.

23. The method as set forth in claim 22, further including moving at least one of the display panels of the plurality of display panels relative to the support device and moving at least one of the display panels of the plurality of display panels relative to at least one of the other display panels of the plurality of display panels.

24. The method as set forth in claim 21, further including positioning a plurality of the advertising displays, which are connected to electronic advertising information, in a spaced apart relationship.

25. The method as set forth in claim 24, further including:
providing digitally stored advertising information to the at least one electronic panel display;
operatively connecting the at least one electronic panel display to at least one splitter;
operatively connecting the at least one splitter is operatively to at least one video receiver;
operatively connecting the at least one video receiver is to at least one video transmitter; and
operatively connecting the at least one video transmitter to at least one processor that utilizes the digitally stored advertising information.

26. The method as set forth in claim 21, further including:
inserting printed advertisements in an exterior shell, having at least one opening therein, and positioned over at least one backing member, wherein the at least one backing member is positioned adjacent to the support frame, wherein the exterior shell and the at least one backing member are operatively connected together to form a pocket for receiving the removable printed advertisement so that the printed advertisement can be viewed through the opening in the exterior shell.
